(19) United States
(12) Patent Application Publication
(10) Pub. No.: US 2022/0201424 A1
(43) Pub. Date: Jun. 23, 2022

(54) WIRELESS CONTROL DEVICE, AND WIRELESS CONTROL SYSTEM

(71) Applicant: Panasonic Intellectual Property Management Co., Ltd., Osaka (JP)

(72) Inventors: Kunihiko SAKAIBARA, Kanagawa (JP); Takuji MAEDA, Osaka (JP); Nobuhiko ARASHIN, Osaka (JP); Kunio FURUTA, Chiba (JP); Jumpei SASAKI, Kanagawa (JP)

(21) Appl. No.: 17/603,635

(22) PCT Filed: Apr. 15, 2020
(86) PCT No.: PCT/JP2020/016529

§ 371 Date: Oct. 14, 2021

(30) Foreign Application Priority Data
Apr. 18, 2019 (JP) 2019-079447

(51) Int. Cl. H04W 4/021; H04W 4/16; H04M 3/56

(52) U.S. Cl. CPC H04W 4/021; H04M 3/568; H04W 4/16

(57) ABSTRACT

A wireless control device is provided with: a first wireless control unit that acquires first information including information indicating first positions of persons by using a first wireless method; a second wireless control unit that connects to wireless devices by using a second wireless method, and acquires second information that includes device identification information for identifying the wireless devices and information indicating second positions of the wireless devices; and an information control unit that selects the first position within a prescribed range from each second position, and specifies person identification information linked with the device identification information of the second position as the person identification information of a person present at the selected first position.

### TECHNICAL FIELD

The present disclosure relates to a radio control apparatus and a radio control system.

### BACKGROUND ART

In recent years, there has been discussion on achieving convenience of facility users in facilities where a lot of people gather together, such as offices, commercial facilities, and accommodation facilities, by use of positions of people, positions of devices carried by the people and/or positions of devices in the facilities.

### CITATION LIST

### Non-Patent Literature

NPL 1: Japanese Patent Application Laid-Open No. 2017-38342

### SUMMARY OF INVENTION

There is, however, room for discussing a method for identifying who the individual is in a facility.

Non-limiting embodiments of the present disclosure facilitate providing a radio control apparatus and a radio control system each capable of identifying who the individual is in a facility.

A radio control apparatus according to one example of the present disclosure includes: a first radio controller, which in operation, acquires first information, using a first radio method, the first information including information indicating a first position of a person; a second radio controller, which in operation, is connected to a radio apparatus, using a second radio method and acquires second information including apparatus identification information and information indicating a second position of the radio apparatus, the apparatus identification information identifying the radio apparatus; and an information controller, which in operation, selects a first position within a predetermined range from each of a plurality of the second positions and identifies person identification information associated with the apparatus identification information of the second position, as person identification information for the person present at the selected first position.

A radio control system according to one example of the present disclosure includes: a radio control apparatus; and a radio apparatus to be connected to the radio control apparatus by radio, in which the radio control apparatus includes: a first radio controller, which in operation, acquires first information, using a first radio method, the first information including information indicating a first position of a person; a second radio controller, which in operation, is connected to the radio apparatus, using a second radio method and acquires second information including apparatus identification information and information indicating a second position of the radio apparatus, the apparatus identification information identifying the radio apparatus; and an information controller, which in operation, selects, for each of a plurality of the second positions, at least a corresponding one of a plurality of the first positions, and identifies person identification information associated with the apparatus identification information of the second position, as person identification information for the person present at the selected first position.

It should be noted that general or specific embodiments may be implemented as a system, an apparatus, a method, an integrated circuit, a computer program, a storage medium, or any selective combination thereof.

According to one embodiment of the present disclosure, it is possible to identify who the individual is in a facility.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram illustrating an exemplary radio system according to an embodiment of the present disclosure;

FIG. 2 is a block diagram illustrating an exemplary configuration of a radio control apparatus according to the embodiment of the present disclosure;

FIG. 3 is a block diagram illustrating an exemplary configuration of a dongle connected to a terminal according to the embodiment of the present disclosure;

FIG. 4 is a flowchart illustrating an example of processing of the radio control apparatus in the embodiment of the present disclosure;

FIG. 5 is a flowchart illustrating a first example of processing for a control target device in the embodiment of the present disclosure;

FIG. 6 is a flowchart illustrating a second example of processing for the control target device in the embodiment of the present disclosure;

FIG. 7 is a flowchart illustrating a third example of processing for the control target device in the embodiment of the present disclosure;

FIG. 8 is a flowchart illustrating a fourth example of processing for the control target device in the embodiment of the present disclosure;

FIG. 9 is a flowchart illustrating a fifth example of processing for the control target device in the embodiment of the present disclosure;

FIG. 10 is a flowchart illustrating a sixth example of processing for the control target device in the embodiment of the present disclosure;

FIG. 11 is a flowchart illustrating a seventh example of processing for the control target device in the embodiment of the present disclosure; and

FIG. 12 is a flowchart illustrating an eighth example of processing for the control target device in the embodiment of the present disclosure.

### DESCRIPTION OF EMBODIMENTS

A preferable embodiment of the present disclosure will be described in detail with reference to the drawings. Note that, constituent elements having substantially the same functions are assigned the same reference numerals, and their overlapping descriptions are omitted in this specification and the drawings.

### One Embodiment

In recent years, an office style so-called “free address” has been increasing. The term “free address” refers to an office style in which employees of an office do not have individually assigned seats and work while sitting on seats of their choice.

In such “free address” offices, there has been discussion on achieving convenience in offices by use of the respective positions of individuals (e.g., employees), and respective positions of devices owned by, carried around, and/or belonging to (hereinafter, may be referred to as “carried by”) the individuals, and/or a position of a device in the office.

There has been discussion, for example, on controlling, in a conference space of an office, a device provided in the conference space, using a position of a person participating in the conference and a position of a device carried by a person and/or a position of a device in the conference space. This controlling of the device allows a conference to proceed smoothly and increases productivity.

Although detection or reception of the position of a device carried by a person, using a radio method, such as Wi-Fi (registered trademark) is conceivable, for example, it is difficult to detect the position of the person who carries the device.

The position of a person is possibly detected from an image captured using a camera, for example. There is, however, room for discussion in viewpoint of privacy protection because an image of a person is captured in this detection method.

Further, the position of a person is possibly detected using a radio method, such as a radar, for example. With this detection method, it is, however, difficult to identify who the detected person is.

In the present embodiment, the position of a person and the position of a device carried by a person are acquired by a combination of a plurality of radio methods, and a person is identified based on the relationship between the two positions. Further, in the present embodiment, an external device is controlled, using the identification result.

<Configuration Example of Radio System>

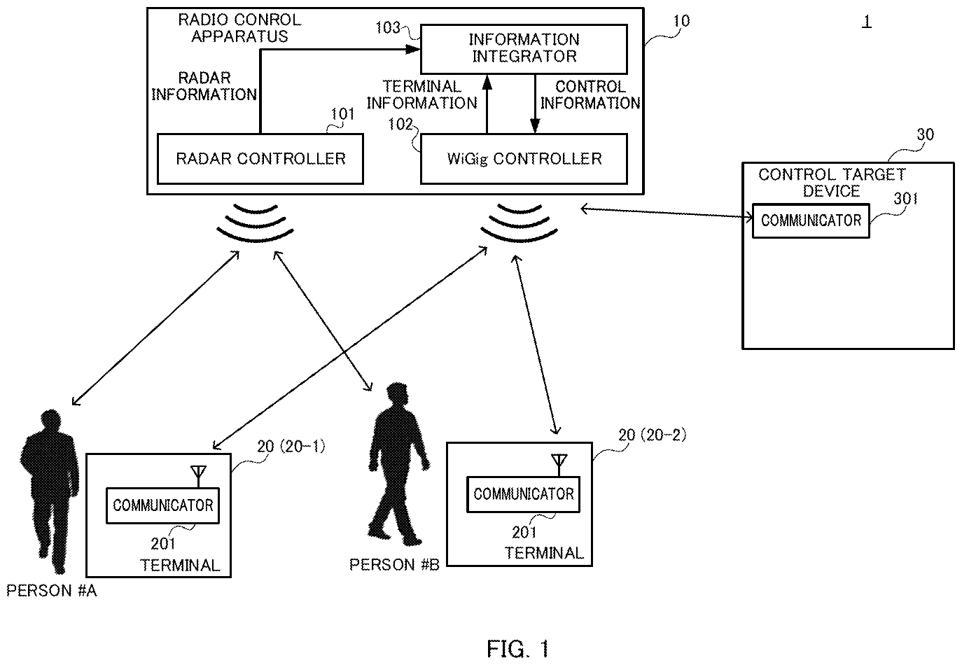

FIG. 1 is a diagram illustrating an example of radio system 1 according to the present embodiment. Hereinafter, a description will be given of an example in which radio system 1 illustrated in FIG. 1 is introduced into an office.

Radio system 1 includes radio control apparatus 10, terminals 20 (terminals 20-1 and 20-2), and control target device (or equipment) 30. In FIG. 1, terminal 20-1 is a terminal 20 carried by person #A, and terminal 20-2 is terminal 20 carried by person #B.

Radio control apparatus 10 is installed, for example, in an office. Radio control apparatus 10 performs radio communication with terminals 20. Further, radio control apparatus 10 detects a position of a target object (person and/or object) present in the office. Further, radio control apparatus 10 controls control target device 30. Radio control apparatus 10 is, for example, in the form of an access point (AP).

Radio control apparatus 10 includes, for example, radar controller 101, WiGig controller 102, and information integrator 103.

Radar controller 101, for example, controls transmission and reception of a radar signal of a millimeter-wave band, and detects the position of a target object present in a detection area of the office. The target objects include a person and an object present in the detection area. Radar controller 101 may also detect movement of the target object. Radar controller 101 acquires the position of a target object including a person and outputs radar information including the information on the acquired position to information integrator 103.

Note that, in the information on the position of the target object included in the radar information, the information on the position of a person may be referred to as “person position information.”

WiGig controller 102 controls communication based on a communication method (hereinafter referred to as “WiGig method”) compliant with the radio communication standard called WiGig (registered trademark). WiGig controller 102, for example, controls transmission and reception of radio signals of the WiGig method, performs communication with terminals 20 present in the communication area of the office, and acquires information identifying the positions of terminals 20 and information identifying terminals 20. WiGig controller 102 transmits and receives data to and from terminals 20.

Note that, the positions of terminals 20 may be each acquired, for example, by receiving information on the position of terminal 20 held by terminal 20 itself. Alternatively, the position of terminal 20 may be acquired by estimating the position of terminal 20 based on a signal received from terminal 20 by WiGig controller 102. WiGig controller 102 acquires the position of terminal 20 and outputs terminal information including information on the acquired position of terminal 20 and information identifying terminal 20 to information integrator 103.

Note that, the information on the position of terminal 20 included in the terminal information may be referred to as “terminal position information,” and the information identifying terminal 20 may be referred to as “terminal identification information.” The terminal identification information is, for example, an identifier that uniquely identifies the terminal, such as a Media Access Control (MAC) address of terminal 20.

Further, WiGig controller 102 controls transmission and reception of radio signals of the WiGig method, and performs communication with control target device 30 present in the communication areas of the office. WiGig controller 102 transmits control information including an instruction of control of control target device 30 to control target device 30, for example.

Information integrator 103 determines a correspondence relationship between a person and terminal 20 based on the radar information and the terminal information. Information integrator 103 selects a position of a person present within a predetermined range from the position of terminal 20, for example. This selection determines the correspondence relationship (association) between the person and the position of terminal 20. Then, information integrator 103 refers to the information identifying the person associated with the apparatus identification information of terminal 20 and identifies the person present at the selected position of the person. This identification determines the correspondence relationship between the person and terminal 20 including the identification information. Then, information integrator 103 controls control target device 30 based on the determined correspondence relationship.

Radio control apparatus 10 may be referred to as a router apparatus, for example. Further, radio control apparatus 10 may be connected to a backbone network, such as the Internet via Ethernet (registered trademark) or the like. Further, a plurality of radio control apparatuses 10 may be connected to each other via Ethernet or by using radio communication of the WiGig method to perform communication by multi-hopping. In this case, radio control apparatuses 10 may be referred to as a “master device,” “slave device,” and “grand-slave device” in order from the nearest to the core network.

Note that, although the following description will be given with an example in which the detection area of radar controller 101 and the communication area of WiGig controller 102 coincide with each other, the present disclosure is not limited to this example. The detection area may include a portion overlapping with the communication area and a portion not overlapping with the communication area, for example.

Terminal 20 is an example of a device carried by a person. Terminal 20 is, for example, a notebook or tablet personal computer (PC), or a smartphone and/or the like. Terminal 20 may be referred to as a station apparatus (STA).

Note that, a plurality of terminals 20 may be devices of the same type (e.g., notebook PC) or devices of different types (e.g., notebook PC and smart phone). Further, one person may have a plurality of terminals 20.

Terminals 20 each include, for example, communicator 201. Communicator 201 performs communication with radio control apparatus 10 based on the WiGig method. Communicator 201 may be built in terminal 20 or may be included in a device attached to terminal 20. The device having a function of communicator 201 and attached to terminal 20 may be referred to as a “dongle.” A configuration of the dongle will be described, hereinafter.

In the following description, communicator 201 performs communication with radio control apparatus 10 based on the WiGig method, but the present disclosure is not limited to this example. Communicator 201 may perform communication with radio control apparatus 10 based on a radio communication method (e.g., near field radio communication method, such as Wi-fi or Bluetooth (registered trademark)) different from the WiGig method, for example. Communicator 201 may perform communication based on a radio communication method with which radio control apparatus 10 or terminal 20 can detect an approximate position of terminal 20, for example.

When radio control apparatus 10 is connected to a plurality of terminals 20, the communication method with terminals 20 may not be the same among the plurality of terminals 20. In this case, radio control apparatus 10 may have a configuration supporting communication using a plurality of communication methods.

Control target device 30 is, for example, a device installed in an office, a device used in an office, and/or a device for managing a system in an office. Control target device 30, for example, is at least one of a display, a microphone, a speaker, a camera, an air conditioning device (air conditioner), a lighting device, and a device for managing a system of a conference space of an office.

Control target device 30 includes, for example, communicator 301. Communicator 301 performs communication with radio control apparatus 10 based on the WiGig method.

Note that, FIG. 1 illustrates an example in which communicator 301 performs communication with radio control apparatus 10 based on the WiGig method, but the present disclosure is not limited to this example. Communicator 301, for example, may perform communication with radio control apparatus 10 based on a radio communication method (e.g., near field radio communication system, such as Bluetooth (registered trademark)) different from the WiGig method. Alternatively, when control target device 30 is wire-connected to radio control apparatus 10, communicator 301 may perform wired-communication with radio control apparatus 10.

Further, control target device 30 and radio control apparatus 10 are not limited to the example in which they are directly connected with each other, and may be connected via a network, such as the Internet and an intranet. In this case, communicator 301 controls signal transmission and reception of communication via the network.

Further, when radio control apparatus 10 controls a plurality of control target devices 30, the communication method (radio and/or wired) with control target device 30 may not be the same among a plurality of control target devices 30. In this case, radio control apparatus 10 may have a configuration supporting communication with a plurality of communication methods.

Note that, communicator 301 may be built in control target device 30 or may be included in a device attached to control target device 30. A device that includes communicator 301 and that is attached to control target device 30 may be referred to as a “converter.” Such a converter, for example, may perform processing relating to the control of control target device 30 (e.g., signal conversion processing) in addition to the processing relating to communication between radio control apparatus 10 and control target device 30 (signal transmission and reception processing).

Note that, the configuration of radio system 1 illustrated in FIG. 1 is an example, and the present disclosure is not limited to this example. In FIG. 1, for example, radio control apparatus 10 is a device different from control target device 30 and performs radio communication with control target device 30, but the present disclosure is not limited thereto. Radio control apparatus 10 may be built in control target device 30 or may be included in a device attached to control target device 30.

The device referred to as a “converter” as described above, for example, may have a function of radio control apparatus 10. In this case, the converter attached to control target device 30 may perform radio communication with terminals 20, using the WiGig method, detect the position of a target object including a person, using the radar method, and determine the correspondence relationship between terminal 20 and the person. Further, the converter may control control target device 30 to which the converter is attached, or may control control target device 30 different from this control target device 30. A converter attached to a display may control the display or may control control target device 30 different from the display (e.g., air conditioner) or may control both of the devices.

<Configuration Example of Radio Control Apparatus>

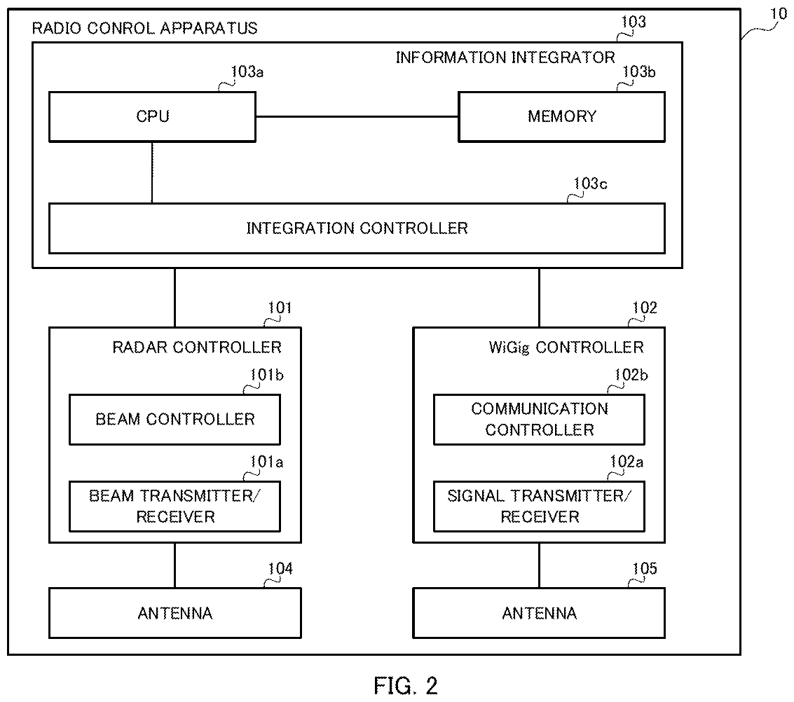

FIG. 2 is a block diagram illustrating an exemplary configuration of radio control apparatus 10 according to the present embodiment.

Radio control apparatus 10 includes radar controller 101, WiGig controller 102, information integrator 103, antenna 104, and antenna 105.

Radar controller 101 includes beam transmitter/receiver 101a and beam controller 101b.

Beam transmitter/receiver 101a forms a transmission beam under the control of beam controller 101b, and transmits a radar signal of a millimeter wave band from antenna 104. Beam transmitter/receiver 101a receives, via antenna 104, a radar signal reflected by a target object and outputs the received radar signal to beam controller 101b.

Beam controller 101b controls scanning of a beam in beam transmitter/receiver 101a. Further, beam controller 101b detects the position of a target object based on the radar signal received by beam transmitter/receiver 101a.

Beam controller 101b, for example, detects a distance to a target object in the direction of a transmission beam in which the radar signal is transmitted, from a difference between the transmission timing and the reception timing of the radar signal. Beam controller 101b calculates a distance to the target object in each direction by causing scanning of the transmission beam in a plurality of directions, and acquires the position of the target object in the detection area. Beam controller 101b outputs radar information including information on the position of the target object to information integrator 103.

Note that, the information included in the radar information is not limited to the position of a target object. Beam controller 101b, for example, may detect the shape of a target object and identify the target object from the detected shape. Beam controller 101b, for example, may identify whether or not the target object is a person. The radar information may include the position of a target object and information indicating an identification result of the target object. Further, when beam controller 101b detects movement of a target object, the radar information may include information on the movement of the target object.

WiGig controller 102 includes signal transmitter/receiver 102a and communication controller 102b.

Signal transmitter/receiver 102a performs transmission processing on a radio signal of the WiGig method under the control of communication controller 102b, and transmits a radio signal from antennas 105. Further, under the control of communication controller 102b, signal transmitter/receiver 102a receives a radio signal via antenna 105, performs reception processing on the received radio signal, and outputs a radio signal resulting from the reception processing to communication controller 102b.

Communication controller 102b controls transmission and reception of signals in signal transmitter/receiver 102a. Communication controller 102b, for example, controls the transmission and reception of signals relating to link establishment with terminals 20 and/or control target device 30, the transmission of a signal requesting terminal 20 for terminal information and/or a signal including data addressed to terminal 20, reception of a signal from terminal 20, including the terminal information and/or data, and transmission of a signal including control information, and/or the like to control target device 30.

Further, communication controller 102b may control the directivity (beam direction) in signal transmitter/receiver 102a. In this case, communication controller 102b may control beamforming training (BFT) for determining the beam to be used for terminal 20 and/or control target device 30 among the beams in a plurality of directions. Communication controller 102b may then control the transmission and reception of signals to and from terminals 20 and/or control target device 30, using the beam determined by the BFT.

Note that, when communication controller 102b controls the directivity (beam direction) in signal transmitter/receiver 102a, communication controller 102b may detect the position of terminal 20 and/or control target device 30. Communication controller 102b, for example, may acquire the position of terminal 20 from the direction of the beam used for terminal 20 and the distance to terminal 20 estimated based on the signal received from terminal 20. In this case, the terminal information acquired from terminal 20 need not include information on the position of terminal 20.

Information integrator 103 includes central processing unit (CPU) 103a, memory 103b, and integration controller 103c.

Memory 103b is an example of an information recording medium. Memory 103b stores therein software relating to an operation of radio control apparatus 10. Further, memory 103b stores therein information for controlling control target device 30. Further, memory 103b stores therein a table indicating a correspondence relationship (association) between the information identifying a person and the terminal identification information. When radio control apparatus 10 is provided in an office, the information identifying a person may be, for example, a personal identification (ID) for identifying an employee of the office, or information, such as the name of an employee. Hereinafter, information identifying a person may be referred to as “person identification information.”

In the example of FIG. 1, for example, terminal 20-1 is terminal 20 carried by person #A, and terminal 20-2 is terminal 20 carried by person #B. In this case, in the table stored in memory 103b, the person identification information of person #A and the terminal identification information of terminal 20-1 are set to correspond (are associated) with each other, and the person identification information of person #B and the terminal identification information of terminal 20-2 are set to correspond (are associated) with each other.

A table stored in memory 103b, for example, may be set based on information registered by, for example, an administrator of an office.

In FIG. 1, an example in which one terminal 20 is associated with one person is illustrated, but the present disclosure is not limited thereto. Two or more terminals 20, for example, may be associated with one person. A notebook PC and a smartphone carried by person #A, for example, may be associated with person #A. Further, two or more persons may be associated with one terminal 20, for example. One notebook PC shared by person #A and person #B, for example, may be associated with person #A and person #B.

CPU 103a performs an arithmetic operation in accordance with an instruction from integration controller 103c. In response to the instruction from integration controller 103c, for example, CPU 103a performs an arithmetic operation based on the software read from memory 103b, and outputs a result of the arithmetic operation to integration controller 103c. Further, CPU 103a performs a predetermined arithmetic operation on the information output from integration controller 103c, and stores the information in memory 103b.

Integration controller 103c executes processing of information integrator 103, using an arithmetic operation in CPU 103a.

Integration controller 103c determines the correspondence relationship between a person and terminal 20 based on radar information and terminal information. Integration controller 103c, for example, selects a position of a person within a predetermined range from the position of terminal 20 based on the person position information and the terminal position information. Integration controller 103c, then, refers to the table stored in memory 103b and determines the person identification information associated with the terminal identification information included in the terminal information. Integration controller 103c, then, determines that the person present at the selected position corresponds to the determined person identification information.

Note that, the determination of the correspondence relationship between a person and terminal 20 is not limited to the example described above. Integration controller 103c, for example, may select the position of a person nearest to the position of terminal 20 and determine that the person identification information associated with the terminal identification information of terminal 20 corresponds to the person present at the selected position.

Note that, when positions of a plurality of persons are included within a predetermined distance from the position of terminal 20, integration controller 103c may determine that the person positioned nearest to the position of terminal 20 among the positions of the plurality of persons corresponds to the determined person identification information.

Further, integration controller 103c controls control target device 30 based on the correspondence relationship between a person and a terminal. Integration controller 103c, for example, transmits control information indicating the content of control to control target device 30, thereby instructing the content of control. An example of the control of control target device 30 will be described, hereinafter.

Note that, the block diagram illustrated in FIG. 2 is an example, and the present disclosure is not limited thereto. Some of the plurality of functional blocks illustrated in FIG. 2 may be omitted or may be included in another functional block, for example.

Memory 103b, CPU 103a, and integration controller 103c may be configured by a single System on a chip (SoC). Further, the SoC may include radar controller 101 and WiGig controller 102.

Further, radio control apparatus 10 illustrated in FIG. 2 may have a communication function based on a communication method different from the WiGig method. When the communication between control target device 30 and radio control apparatus 10 illustrated in FIG. 1 uses a communication method different from the WiGig method, for example, radio control apparatus 10 may have a function of controlling communication based on this communication method.

Further, the configuration of radio control apparatus 10 illustrated in FIG. 2 may be distributed to a plurality of apparatuses. A configuration may be employed, for example, in which radar controller 101 and antenna 104 are be included in another apparatus (e.g., radar apparatus) and this other apparatus and radio control apparatus 10 are connected to each other. Alternatively, a configuration may be employed, for example, in which WiGig controller 102 and antennas 105 are included in another apparatus (e.g., WiGig communication apparatus) and this other apparatus and radio control apparatus 10 are connected to each other.

<Configuration Example of Dongle>

Next, a description will be given of an example in which the functions of communicator 201 of terminal 20 illustrated in FIG. 1 are included in a dongle to be attached to terminal 20 illustrated in FIG. 1.

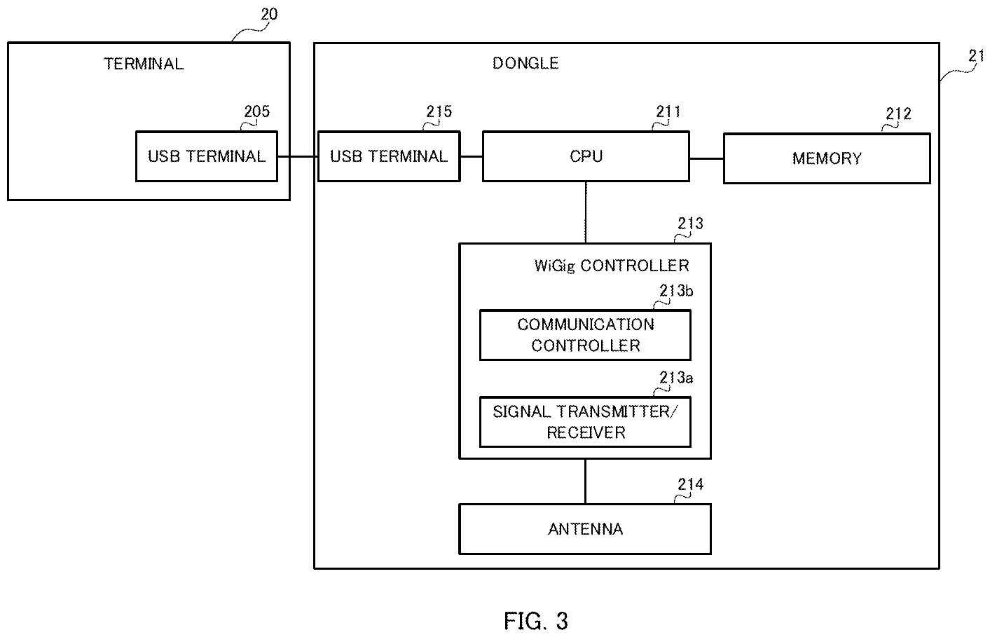

FIG. 3 is a block diagram illustrating an example of a configuration of dongle 21 connected to terminal 20 according to the present embodiment.

Dongle 21 has the functions of communicator 201 of terminal 20 illustrated in FIG. 1. Dongle 21, for example, includes CPU 211, memory 212, WiGig controller 213, antenna 214, and Universal Serial Bus (USB) terminal 215.

Memory 212 is an example of an information recording medium. Memory 212 stores therein software relating to an operation of the WiGig method. Memory 212 may store therein terminal information of terminal 20.

CPU 211 performs an arithmetic operation in accordance with an instruction from WiGig controller 213. CPU 211, for example, performs an arithmetic operation based on the software read from memory 212 in accordance with the instruction from WiGig controller 213 and outputs a result of the arithmetic processing to WiGig controller 213. Further, CPU 211 performs a predetermined arithmetic operation on the information output from WiGig controller 213 and stores the information in memory 212.

WiGig controller 213 controls communication based on the WiGig method. Further, WiGig controller 213 transmits terminal information acquired from terminal 20 to radio control apparatus 10 via antenna 214. WiGig controller 213, for example, controls transmission and reception of radio signals of the WiGig method, and performs data communication between terminal 20 and radio control apparatus 10.

WiGig controller 213 includes signal transmitter/receiver 213a and communication controller 213b.

Signal transmitter/receiver 213a performs transmission processing on a radio signal of the WiGig method under the control of communication controller 213b and transmits a radio signal from antenna 214. Further, under the control of communication controller 213b, signal transmitter/receiver 213a receives a radio signal via antenna 214, performs reception processing on the received radio signal, and outputs a radio signal resulting from the reception processing to communication controller 213b.

Communication controller 213b controls transmission and reception of signals in signal transmitter/receiver 213a. Communication controller 213b, for example, controls transmission of signals relating to link establishment with radio control apparatus 10, reception of a signal requesting terminal information and/or a signal including data addressed to terminal 20, transmission of a signal including terminal information and/or data.

Further, communication controller 213b may control the directivity (beam direction) in signal transmitter/receiver 213a. In this case, communication controller 213b may control beamforming training (BFT) for determining the beam to be used for radio control device 10 among the beams in a plurality of directions. Communication controller 213b may then control the transmission and reception of signals to and from radio control apparatus 10, using the beam determined by the BFT.

USB terminal 215 is an interface connected to USB terminal 205 of terminal 20 via a USB cable to transmit and receive information to and from terminal 20.

Note that, the connection between dongle 21 and terminal 20 is not limited to the example using USB terminals and a USB cable. Other terminals and a cable may be used as long as dongle 21 and terminal 20 are connectable, and radio connection may be used.

The functions of dongle 21 may be included in terminal 20. Communicator 201 of terminal 20 illustrated in FIG. 1, for example, may have the functions of dongle 21.

<Example of Processing Flow of Radio Control Apparatus>

Next, an example of a processing flow in radio control apparatus 10 will be described.

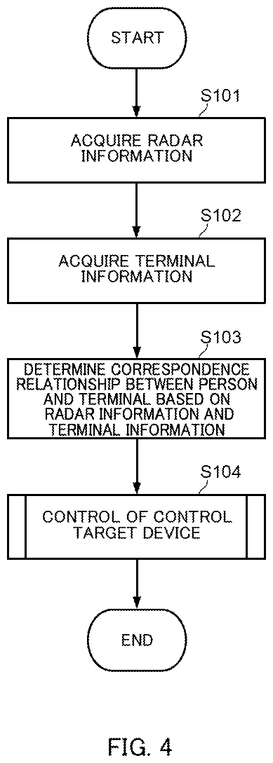

FIG. 4 is a flowchart illustrating an example of processing by radio control apparatus 10 in this embodiment.

Radar controller 101 acquires radar information (S101). Radar controller 101 outputs the acquired radar information to information integrator 103.

WiGig controllers 102 acquire terminal information (S102). WiGig controller 102 outputs the acquired terminal information to information integrator 103.

Information integrator 103 determines the correspondence relationship between a person and terminal 20 based on the radar information and the terminal information (S103). Information integrator 103, for example, selects the position of a person present within a predetermined range from the position of terminal 20, or the position of a person present at a position nearest to the position of terminal 20. Then, information integrator 103 identifies the person identification information associated with the apparatus identification information of terminal 20 as the person identification information of the person present at the selected position of the person, thereby determining the correspondence relationship between terminal 20 and the person including both the position information and the identification information.

Information integrator 103 controls control target device 30, using the determined correspondence relationship (S104). The flow illustrated in FIG. 4 thus ends.

Next, an example in which radio control apparatus 10 controls control target device 30 will be described.

### FIRST EXAMPLE

In a first example, an example will be described in which control target device 30 is a display provided in a conference room (or conference space) of an office. Radio control apparatus 10, for example, may have information on the position of the display in advance.

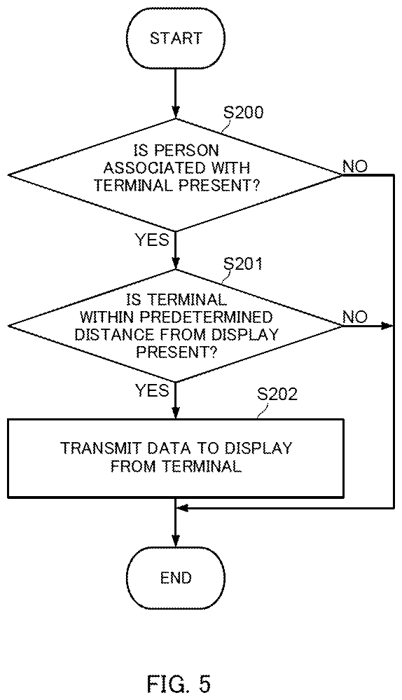

FIG. 5 is a flowchart illustrating the first example of processing for control target device 30 in the present embodiment. The processing illustrated in FIG. 5 corresponds to an example of the processing in S104 illustrated in FIG. 4. The processing illustrated in FIG. 5 may be executed at a predetermined cycle or may be executed when radio control apparatus 10 receives an instruction from the outside.

Information integrator 103 determines whether or not a person associated with terminal 20 is present (S200).

When there is no person associated with terminal 20 (NO in S200), the flow illustrated in FIG. 5 ends. Note that, the case where there is no person associated with terminal 20 includes a case where no terminal 20 is present, for example, a case where radio control apparatus 10 makes no radio connection to terminal 20.

When a person associated with terminal 20 is present (YES in S200), information integrator 103 determines whether or not terminal 20 is present within a predetermined distance from the display (S201). When the display is fixed, for example, information integrator 103 may have information on the position of the fixed display in advance. Further, when the display is not fixed, information integrator 103 may acquire the position of the display from a communicator (e.g., communicator 301 of FIG. 1) connected to the display.

When no terminal 20 is present within a predetermined distance from the display (NO in S201), the flow illustrated in FIG. 5 ends. When terminal 20 is present within the predetermined distance from the display (YES in S201), information integrator 103 acquires data relating to a display screen from terminal 20 and transmits the data to the display (S202). The display controls displaying based on the received data.

The flow illustrated in FIG. 5 then ends.

Note that, when the converter attached to the display communicates with radio control apparatus 10, the converter is connected to the display via, for example, a display cable (High-Definition Multimedia Interface (HDMI) (registered trademark) cable) capable of transferring image signals. The converter then decodes the image signals received from radio control apparatus 10, performs rendering processing, and outputs (transfers) the decoded image signals to the display via the display cable.

The converter may also include the functions of radio control apparatus 10. In this case, the converter may perform the processing illustrated in FIG. 4 and the processing illustrated in FIG. 5.

### SECOND EXAMPLE

In a second example, an example will be described in which control target device 30 is a microphone and a speaker used in a conference room of an office. Radio control apparatus 10, for example, may have information on positions of the microphone and speaker in advance.

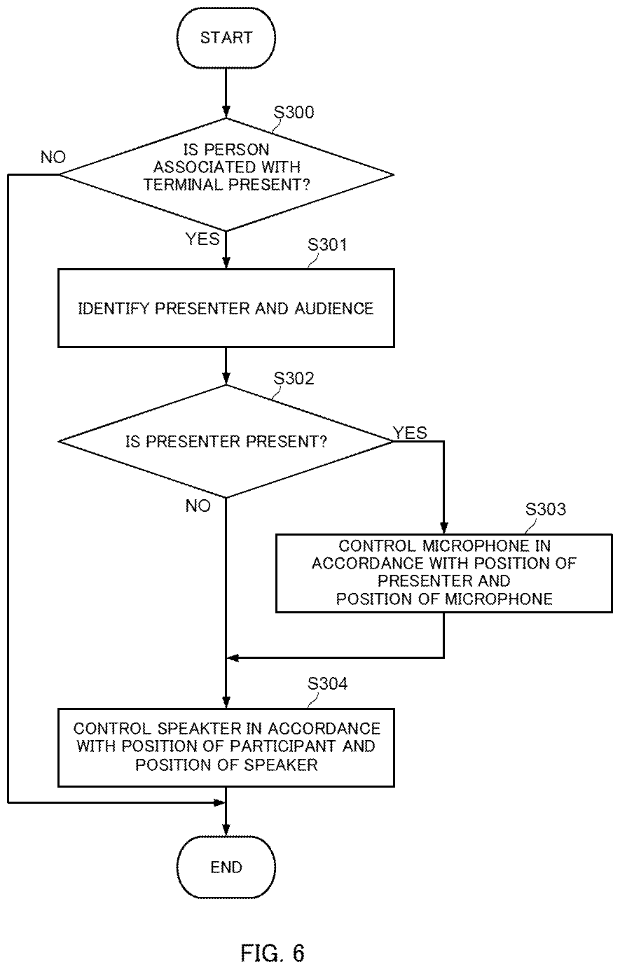

FIG. 6 is a flowchart illustrating the second example of processing for control target device 30 in this embodiment. The processing illustrated in FIG. 6 corresponds to an example of the processing in S104 illustrated in FIG. 4. Further, the processing illustrated in FIG. 6 may be executed at a predetermined cycle or may be executed when radio control apparatus 10 receives an instruction from the outside.

Information integrator 103 determines whether or not a person associated with terminal 20 is present (S300).

When there is no person associated with terminal 20 (NO in S300), the flow illustrated in FIG. 6 ends.

When a person associated with terminal 20 is present (YES in S300), information integrator 103 sets the person associated with terminal 20 to be a participant of the conference, and identifies a presenter and an audience from among the participants (S301). Information integrator 103, for example, may identify participants close to each other in position (participants gather in a specific range) among the participants are as audiences, and may identify a participant distant from the audiences in position as a presenter. Alternatively, information integrator 103 may identify a participant within a predetermined distance from the display as a presenter and identify a participant other than the presenter as an audience among the participants.

Information integrator 103 determines whether or not a presenter is present (S302).

When there is no presenter (NO in S302), the processing in S304 is executed.

When a presenter is present (YES in S302), information integrator 103 controls the microphone in accordance with the position of the presenter and the position of the microphone (S303). Information integrator 103, for example, instructs the microphone to increase the input volume (which may be referred to as an input gain or input sensitivity) of the microphone as the position of the presenter is farther away from the microphone. Alternatively, in a case where a plurality of microphones are provided in the conference room, information integrator 103 may issue an instruction to set the microphone closest to the position of the presenter to be in an ON state (active state) and to set other microphones to be in an OFF state (inactive state). Then, the processing in S304 is executed.

Next, information integrator 103 controls a speaker in accordance with the positions of the participants and the position of the speaker (S304). Information integrator 103, for example, issues an instruction to increase the output volume of the speaker as the average (average position) of the positions of the participants is further away from the speaker. Alternatively, in a case where a plurality of speakers are provided, information integrator 103 may issue an instruction to set the output volume of each of the speakers and/or the ON/OFF state of each of the speakers based on the positions of the participants.

Then, the flow illustrated in FIG. 6 ends.

In the second example, since the acoustic devices, such as the microphone and the speaker, are controlled in accordance with the positions of the participants including the presenter, no manual control is required, and the conference can proceed, smoothly.

Note that, in the second example, a description has been given with a case where a person associated with terminal 20 is set to be a participant of the conference, but the present disclosure is not limited thereto. A person not associated with terminal 20 may be set to be a participant, for example. In this case, for example, the processing in S300 for determining whether or not a person associated with terminal 20 is present may not be executed, or the processing in S103 illustrated in FIG. 4 may not be executed.

Further, an example has been described in which information integrator 103 controls the input volume of the microphone and/or controls the ON/OFF of the microphone in S303 of FIG. 6, but the present disclosure is not limited to this example. Information integrator 103 may control the directivity of the microphone. When a presenter is present (S302 in FIG. 6), for example, information integrator 103 controls the directivity of the microphone toward the position where the presenter is present. This control allows the microphone to efficiently collect the voice of the presenter without picking up sounds (e.g., noise) different from the voice of the presenter.

Further, an example has been described in which information integrator 103 performs control of the output volume of the speaker and/or control of turning ON and OFF of the speaker in S304 of FIG. 6, the present disclosure is not limited thereto. Information integrator 103 may control the directivity of the speaker. Information integrator 103, for example, controls the directivity of the speaker in the direction of the position of the participant. This control suppresses leaking of the sound output from the speaker to the outside.

A free address office, for example, has no dividers to the outside (such as partitions) around the conference space in many cases. Therefore, the noise from the outside increases during the conference, and the sound leakage to the outside also increases. Controlling the acoustic devices, such as a microphone and a speaker based on the positions of the participants including the presenter makes it possible to suppress the microphone from picking up an external noise and the speaker from generating sound leakage to the outside. Further, it is possible to omit labor such as manually moving the microphone and/or manually adjusting the volume of the speaker.

### THIRD EXAMPLE

In a third example, an example will be described in which control target device 30 is a camera used in a conference room of an office. The camera, for example, captures an image of a presenter during the conference. Radio control apparatus 10 may also have information about the position of the camera in advance.

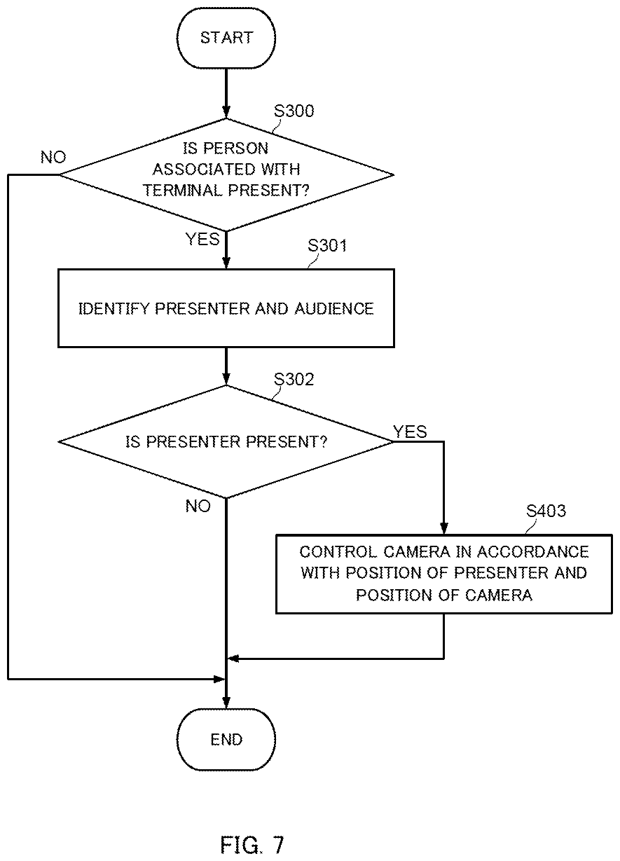

FIG. 7 is a flowchart illustrating the third example of processing for control target device 30 in the present embodiment. The processing illustrated in FIG. 7 corresponds to an example of the processing in S104 illustrated in FIG. 4. Further, the processing illustrated in FIG. 7 may be executed at a predetermined cycle or may be executed when radio control apparatus 10 receives an instruction from the outside.

Note that, in FIG. 7, the same processing as the processing in FIG. 6 is denoted by the same reference numeral, and a description thereof is omitted. The flowchart illustrated in FIG. 7 is different from the flowchart illustrated in FIG. 6 in processing subsequent to S302.

When there is no presenter (NO in S302), the flow illustrated in FIG. 7 ends. When a presenter is present (YES in S302), information integrator 103 controls the camera in accordance with the position of the presenter and the position of the camera (S403). Information integrator 103, for example, instructs the camera to adjust at least one of a pan angle, a tilt angle, and a zoom magnification that determines a capturing range of the camera.

Then, the flow illustrated in FIG. 7 ends.

In the third example, since the capturing device, such as a camera, is controlled in accordance with the position of the presenter, no manual control is required, and the conference can proceed, smoothly.

Note that, in the third example, an example has been described in which a person associated with terminal 20 is set to be a participant of the conference, but the present disclosure is not limited thereto. A person not associated with terminal 20 may be set to be a participant, for example. In this case, for example, the processing in S300 for determining whether or not a person associated with terminal 20 is present may not be executed, or the processing in S103 illustrated in FIG. 4 may not be executed.

### FOURTH EXAMPLE

In a fourth example, an example will be described in which control target device 30 is an air conditioning device (air conditioner) that is provided in a conference room of an office. Radio control apparatus 10 may have information about the position of the air conditioner in advance, for example.

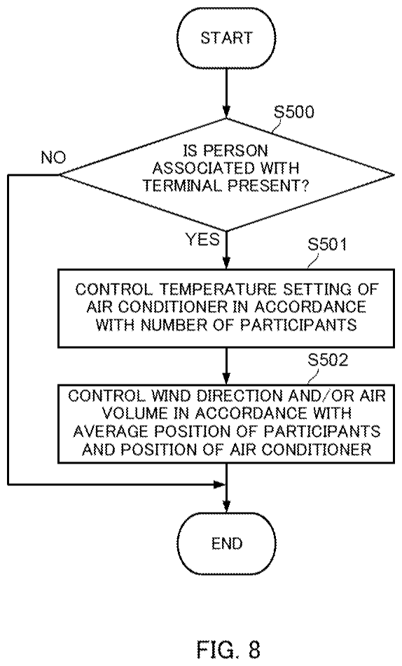

FIG. 8 is a flowchart illustrating the fourth example of processing for control target device 30 in the present embodiment. The processing illustrated in FIG. 8 corresponds to an example of the processing in S104 illustrated in FIG. 4. The processing illustrated in FIG. 8 may be executed at a predetermined cycle or may be executed when the radio control apparatus 10 receives an instruction from the outside.

Information integrator 103 determines whether or not a person associated with terminal 20 is present (S500).

When there is no person associated with terminal 20 (NO in S500), the flow illustrated in FIG. 8 ends.

When a person associated with terminal 20 is present (YES in S500), information integrator 103 sets the person associated with terminal 20 to be a participant in the conference, and controls a temperature setting of the air conditioner in accordance with the number of participants (how many participants) (S501). When the temperature in the conference room is higher than an optimum temperature, for example, information integrator 103 may issue an instruction to increase the lowering range of the temperature setting as the number of participants increases. Alternatively, when the temperature in the conference room is lower than the optimum temperature, information integrator 103 may issue an instruction to increase the increasing range of the temperature setting as the number of participants increases.

Information integrator 103 then controls a wind direction and/or air volume of the air conditioner in accordance with the average position of the participants and the position of the air conditioner (S502). Information integrator 103, for example, may issue an instruction to direct the wind direction of the air conditioner to the direction of the average position of the participants and/or an instruction to adjust the air volume such that the air volume increases with respect to the average position of the participants.

Then, the flow illustrated in FIG. 8 ends.

Note that, as to the processing in S501 and in S502 illustrated in FIG. 8, at least one of them may be performed.

In the fourth example, since the air conditioning device is controlled in accordance with the positions of the participants, no manual control is required, and the conference can proceed, smoothly.

Note that, in the fourth example, an example has been described in which the person associated with terminal 20 is set to be a participant of the conference, but the present disclosure is not limited to this. A person not associated with terminal 20 may be set to be a participant, for example. In this case, for example, the processing in S500 for determining whether or not a person associated with terminal 20 is present may not be executed, or the processing in S103 illustrated in FIG. 4 may not be executed.

Note that, in S501 of FIG. 8, the optimum temperature is not particularly limited. The optimum temperature may be set in advance, or may be manually set by a participant or the like of the conference, for example. Alternatively, the optimum temperature may be set in radio control apparatus 10. Information integrator 103 of radio control apparatus 10 may previously store the size (floor area and/or volume) of the conference room provided with the air conditioner in memory 103b, determine the density of the people in the conference room in accordance with the ratio of the number of participants to the size of the conference room and set the optimum temperature in accordance with the determined density.

### FIFTH EXAMPLE

In a fifth example, similar to the fourth example, an example will be described in which control target device 30 is an air conditioning device (air conditioner) provided in a conference room of an office. Radio controller 10 may have information about the position of the air conditioner in advance, for example.

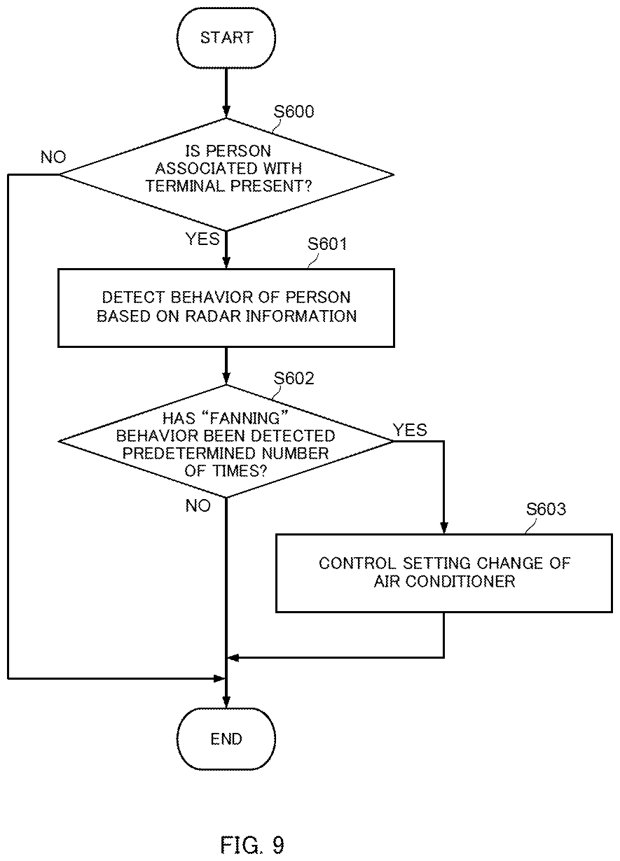

FIG. 9 is a flowchart illustrating the fifth example of processing for control target device 30 in the present embodiment. The processing illustrated in FIG. 9 corresponds to an example of the processing in S104 illustrated in FIG. 4. The processing illustrated in FIG. 9 may be executed at a predetermined cycle, or may be executed when the radio control apparatus 10 receives an instruction from the outside.

Information integrator 103 determines whether or not a person associated with terminal 20 is present (S600).

When there is no person associated with terminal 20 (NO in S600), the flow illustrated in FIG. 9 ends.

When a person associated with terminal 20 is present (YES in S600), information integrator 103 sets the person associated with terminal 20 to be a participant of the conference and detects the behavior of the participant based on radar information (S601).

Information integrator 103 determines whether or not a “fanning” behavior (fanning himself or herself) of the participant is detected a predetermined number of times (S602).

When the “fanning” behavior of the participant is not detected the predetermined number of times (NO in S602), the flow illustrated in FIG. 9 ends.

When the “fanning” behavior of the participant is detected the predetermined number of times (YES in S602), information integrator 103 controls a setting change of the air conditioner (S603). Information integrator 103, for example, may issue at least one of an instruction to lower the temperature setting of the air conditioner, an instruction to change the wind direction toward the direction of the participant who has performed the “fanning” behavior, and an instruction to increase the air volume.

Then, the flow illustrated in FIG. 9 ends.

In the fifth example, since the air conditioner is controlled in accordance with the behavior of a participant, no manual control is required, and the conference can proceed, smoothly.

Note that, in the fifth example, an example has been described in which the person associated with terminal 20 is set to be a participant of the conference, but the present disclosure is not limited thereto. A person not associated with terminal 20 may be set to be a participant, for example. In this case, for example, the processing in S600 for determining whether or not a person associated with terminal 20 is present may not be executed, or the processing in S103 illustrated in FIG. 4 may not be executed.

### SIXTH EXAMPLE

In a sixth example, an example will be described in which control target device 30 is a lighting device provided in a conference room of an office. Radio control apparatus 10 may have information about the position of the lighting device in advance, for example.

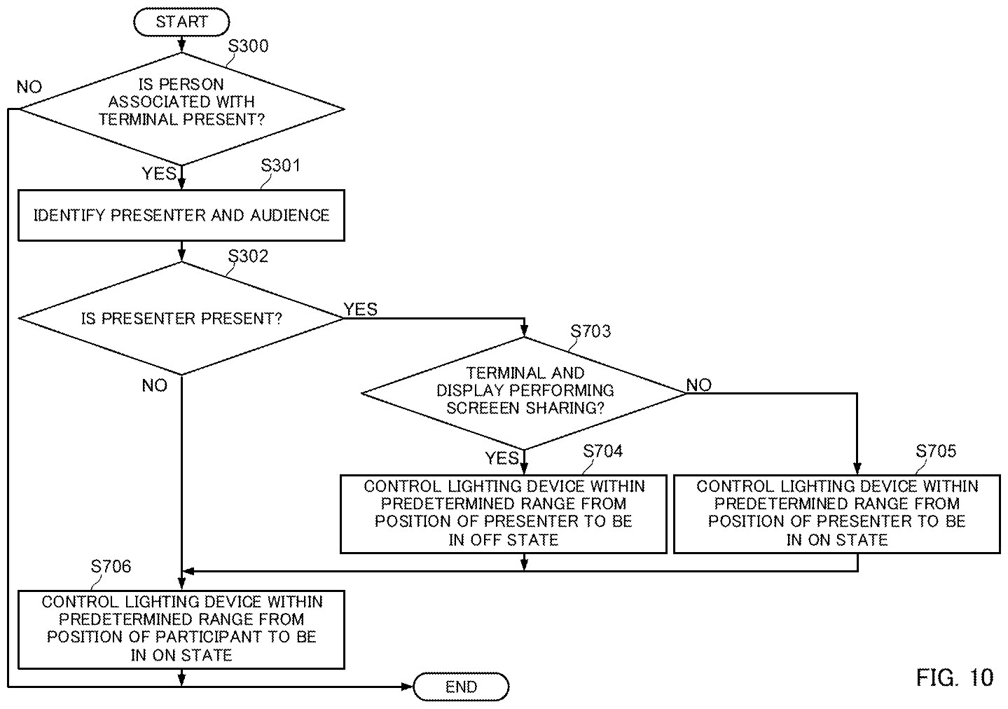

FIG. 10 is a flowchart illustrating the sixth example of processing for control target device 30 in the present embodiment. The processing illustrated in FIG. 10 corresponds to an example of the processing in S104 illustrated in FIG. 4. The processing illustrated in FIG. 10 may be executed at a predetermined cycle, or may be executed when radio control apparatus 10 receives an instruction from the outside.

In FIG. 10, the same processing as the processing in FIG. 6 is denoted by the same reference numeral, and a description thereof is omitted. The flowchart illustrated in FIG. 10 is different from the flowchart illustrated in FIG. 6 in processing subsequent to S302.

When there is no presenter (NO in S302), the processing in S706 is executed.

When a presenter is present (YES in S302), information integrator 103 determines whether or not terminal 20 associated with the presenter performs screen sharing with the display (S703). As illustrated in the first example, for example, information integrator 103 may determine that terminal 20 performs screen sharing with the display when the data relating to the display screen is acquired from terminal 20 associated with the presenter and transmitted to the display.

When screen sharing is performed (YES in S703), that is, when the presenter presents the screen using the displaying of the display, information integrator 103 controls the lighting device that illuminates a predetermined range from the position of the presenter to be in the OFF state (S704). Then, the processing in S706 is executed.

When no screen sharing is performed (NO in S703), that is, when the presenter does not use displaying of the display, information integrator 103 controls the lighting device that illuminates a predetermined range from the position of the presenter to be in the ON state (S705). Then, the processing in S706 is executed.

Next, information integrator 103 controls the lighting device that illuminates a predetermined range from a position of a participant excluding the presenter to be in the ON state (S706).

Then, the flow illustrated in FIG. 10 ends.

In the sixth example, the ON/OFF of the lighting device around the presenter is controlled in accordance with the position of the presenter and whether or not the presenter is in the middle of the presentation, and acoustic devices, such as a microphone and a speaker of the lighting device around participants are controlled in accordance with the positions of the participants; thus, no manual control is required, and the conference can proceed, smoothly.

Note that, in the six example, an example has been described in which the person associated with terminal 20 is set to be a participant of the conference, but the present disclosure is not limited thereto. A person not associated with terminal 20 may be set as a participant, for example. In this case, for example, the processing in S300 for determining whether or not there is a person associated with terminal 20 may not be executed, or the processing in S103 illustrated in FIG. 4 may not be executed.

### SEVENTH EXAMPLE

In a seventh example, an example will be described in which control target device 30 is a device for managing a system of a conference room of an office, for example, a reservation management device.

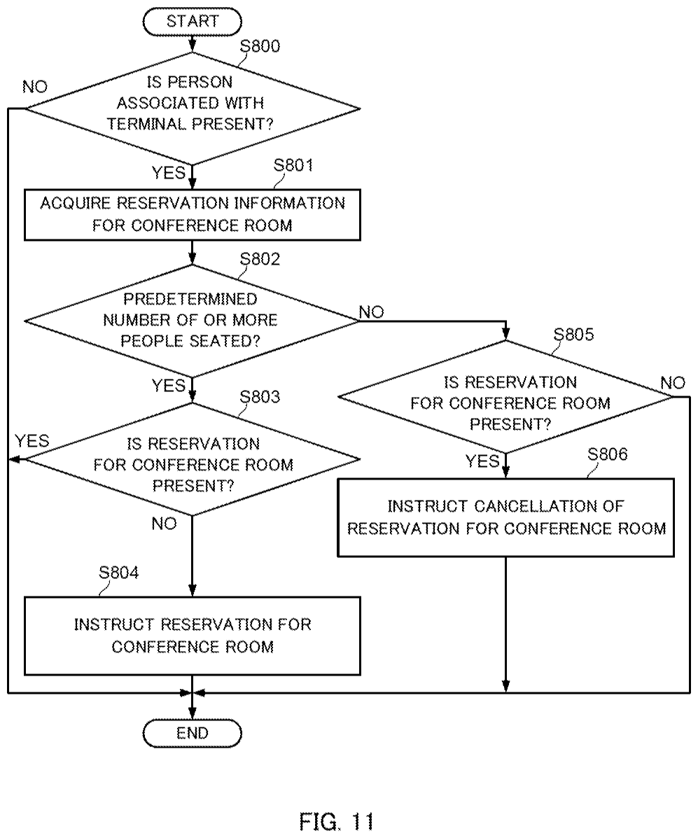

FIG. 11 is a flowchart illustrating the seventh example of processing for control target device 30 in the present embodiment. The processing illustrated in FIG. 11 corresponds to an example of processing in S104 illustrated in FIG. 4. The processing illustrated in FIG. 11 may be executed at a predetermined cycle, or may be executed when radio control apparatus 10 receives an instruction from the outside.

Information integrator 103 determines whether or not a person associated with terminal 20 is present (S800).

When there is no person associated with terminal 20 (NO in S800), the flow illustrated in FIG. 11 ends.

When a person associated with terminal 20 is present (YES in S800), information integrator 103 sets the person associated with terminal 20 to be a participant and acquires reservation information for the conference room (S801).

Information integrator 103 determines whether or not a predetermined number or more of participants are seated in the conference room (S802). The determination of whether or not a participant is seated may be made by detecting whether or not the posture of the participant is a seated posture based on radar information, for example.

Note that, the processing in S802 is an example of determining whether or not a user of the conference room is present. Whether or not a user of the conference room is present may be determined by processing different from the processing in S802. The determination may be made based on whether or not a predetermined number of participants are present, for example. Alternatively, the determination may be made based on whether a participant stays in the conference room for more than a predetermined period of time.

When a predetermined number (e.g., two) or more of participants are seated (YES in S802), information integrator 103 determines whether or not the conference room is reserved based on the reservation information (S803).

When the conference room is reserved (YES in S803), the flowchart illustrated in FIG. 11 ends.

When the conference room is not reserved (NO in S803), information integrator 103 issues an instruction to reserve the conference room (S804). Information integrator 103, for example, may generate reservation information in which the person associated with terminal 20 is set as a user (reserving person) of the conference room, and transmit the reservation information to the reservation management device. The flow illustrated in FIG. 11 then ends.

When the predetermined number or more of participants are not seated (NO in S802), information integrator 103 determines whether or not the conference room is reserved based on the reservation information (S805).

When the conference room is not reserved (NO in S805), the flow illustrated in FIG. 11 ends.

When the conference room is reserved (YES in S805), information integrator 103 issues an instruction to cancel the reservation for the conference room (S806).

The flow illustrated in FIG. 11 then ends.

In the seventh example, since the reservation information is updated in accordance with the reservation state of the conference, the presence or absence of a participant in the conference room, it is possible to improve the efficiency of the use state of the conference room without manually updating the reservation information.

Note that, in the seventh example, an example has been described in which the person associated with terminal 20 is set to be a participant of a conference, but the present disclosure is not limited thereto. A person not associated with terminal 20 may be set to be a participant, for example. In this case, for example, the processing in S800 for determining whether or not a person associated with terminal 20 is present may not be executed, or the processing in S103 illustrated in FIG. 4 may not be executed.

### EIGHTH EXAMPLE

In an eighth example, an example will be described in which control target device 30 is a device for managing a system of a conference room of an office, for example, a conference management device.

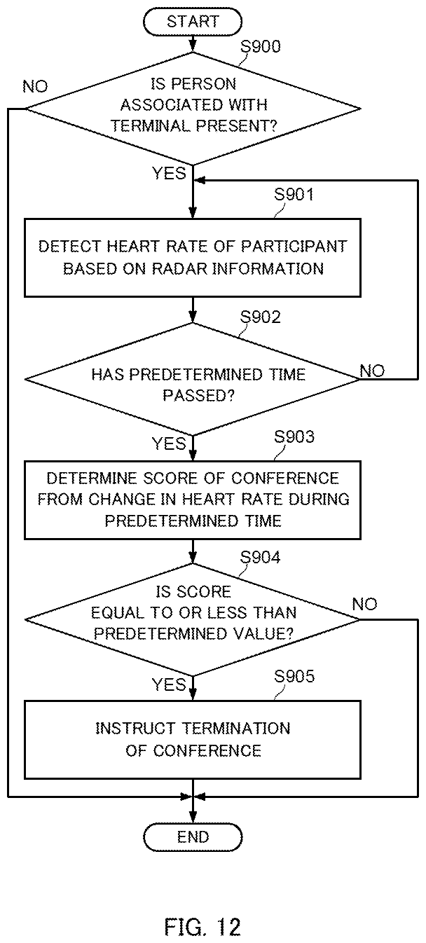

FIG. 12 is a flowchart illustrating the eighth example of processing for control target device 30 in the present embodiment. The processing illustrated in FIG. 12 corresponds to an example of the processing in S104 illustrated in FIG. 4. The processing illustrated in FIG. 12 may be executed at a predetermined cycle, or may be executed when radio control apparatus 10 receives an instruction from the outside.

Information integrator 103 determines whether or not a person associated with terminal 20 is present (S900).

When there is no person associated with terminal 20 (NO in S900), the flow illustrated in FIG. 12 ends.

When a person associated with terminal 20 is present (YES in S900), information integrator 103 sets the person associated with terminal 20 to be a participant of the conference, and detects the heart rate of the participant based on radar information (S901).

Information integrator 103 determines whether or not a predetermined time has elapsed (S902).

When the predetermined time has not elapsed (NO in S902), the processing returns to the processing in S901, and the processing in S901 is executed until the predetermined time elapses.

When the predetermined time has elapsed (YES in S902), information integrator 103 determines a score of the conference based on a change in the heart rate for the predetermined time (S903).

The score of a conference is an example of an index of quality of the conference, for example. The score of a conference may be a numerical value indicating liveliness in the conference. Information integrator 103, for example, may calculate a difference between the local maximum value and the local minimum value of the heart rate of each participant, and determine that the larger the difference calculated for each participant is, the more sharp the conference is and the more lively the conference is. Meanwhile, information integrator 103 may determine that the smaller the difference calculated for each participant is, the less sharp the conference is and the less lively the conference is. Further, when the average value of the heart rate increases with the passage of time, information integrator 103 may determine that the conference becomes more lively with the passage of time. Meanwhile, when the average value of the heart rate decreases with the elapse of time, information integrator 103 may determine that the conference becomes less lively with the elapse of time.

Information integrator 103 determines whether or not the score of the conference is equal to or less than a predetermined value (S904).

When the score the conference is not equal to or less than the predetermined value (NO in S904), the flow illustrated in FIG. 12 ends.

When the score of the conference is equal to or less than the predetermined value (YES in S904), information integrator 103 instructs the conference management device to end the conference (S905). When the conference management device is instructed to end the conference by information integrator 103, the conference management device may notify the participants of the conference of the end of the conference, using voice and/or character information.

The flow illustrated in FIG. 12 then ends.

In the eighth example, the numerical value can be obtained in accordance with the state of liveliness in the conference, and the activation state of the conference can be quantitatively evaluated. Further, since the continuation or termination of the conference can be determined in accordance with the activation state of the conference, the conference can proceed, smoothly.

In the eighth example, an example has been described in which the person associated with terminal 20 is set to be a participant of the conference, but the present disclosure is not limited to this. A person not associated with terminal 20 may be set to be a participant, for example. In this case, for example, the processing in S900 for determining whether or not a person associated with terminal 20 is present may not be executed, or the processing in S103 illustrated in FIG. 4 may not be executed.

Further, in FIG. 12, an example has been described in which information integrator 103 determines the score of a conference based on a change in the heart rate for a predetermined period of time, and when the score of the conference is equal to or less than a predetermined value, an instruction to end the conference is issued. The present disclosure is not limited to this example, however. Information integrator 103, for example, may repeat the determination of a score of the conference every predetermined time, and may issue an instruction to end the conference when a score equal to or less than the predetermined value is determined a predetermined number of times in a row.

Note that, two or more of the first to the eighth examples described above may be combined, or two or more of the first to the eighth examples may be performed simultaneously or in parallel.

Note that, the examples of control target device 30 are not limited to the first to the eighth examples described above. Further, the place where the radio control apparatus 10 is provided is not limited to a conference room of an office.

As has been described above, in radio control apparatus 10 according to the present embodiment, radar controller 101 acquires radar information including the person position information, using a radar method (an example of the first radio method). WiGig controller 102 is connected to terminal 20, using the WiGig method (an example of the second radio system) and acquires terminal information including terminal identification information identifying terminal 20 and terminal position information on terminal 20. Information integrator 103 then selects the position of the corresponding person with respect to the position of terminal 20 indicated by the terminal position information and identifies the person at the selected position of the person by the person identification information associated with the terminal identification information.

With this configuration, it is possible to identify who the individual is in the facility. This configuration, for example, involves no capturing of an image of a person, using a camera; thus, it is possible to reduce the stress on collection of personal information felt by a user using the facility. For this reason, it is possible to operation radio system 1 according to the present embodiment without giving the user a sense of anxiety. Further, this configuration involves no advanced processing, such as face authentication on an image captured using a camera; thus, it is possible to realize a low-cost apparatus.

Further, in the present embodiment, an example has been described in which control target device 30 is controlled on the basis of an identification result of identifying a person associated with terminal 20. This control makes it possible to improve convenience for people present in the facility.

Furthermore, the expression “ . . . er(or)” used in the above embodiments may be replaced with other expressions such as “ . . . circuitry”, “ . . . device”, “ . . . unit”, or “ . . . module.”

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be formed of individual chips, or may be formed of one chip so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas. Some non-limiting examples of such a communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

Various embodiments have been described with reference to the drawings hereinabove. Obviously, the present disclosure is not limited to these examples. Obviously, a person skilled in the art would arrive at variations and modification examples within a scope described in claims, and it is understood that these variations and modifications are within the technical scope of the present disclosure. Further, each component of the above-mentioned embodiments may be combined optionally without departing from the spirit of the disclosure.

Specific examples of the present disclosure have been described thus far, but these examples are only exemplary, and are not to limit the claims. Techniques recited in the claims include, for example, variations and/or modifications of the specific examples exemplified above.

The disclosure of the specification, drawings and abstract contained in Japanese Patent Application No. 2019-079447, filed on Apr. 18, 2019, is incorporated herein by reference in its entirety.

### INDUSTRIAL APPLICABILITY

One example of the present disclosure is suitable for radio communication systems.

### REFERENCE SIGNS LIST

1 Radio system
10 Radio control apparatus
20, 20-1, 20-2 Terminal
21 Dongle
30 Control target device
101 Radar controller
101a Beam transmitter/receiver
101b Beam controller
102, 213 WiGig controller
102a, 213a Signal transmitter/receiver
102b, 213b Communication controller
103 Information integrator
103a, 211 CPU
103b, 212 Memory
103c Integration controller
104, 105, 214 Antenna
201, 301 Communicator
205, 215 USB terminal

1. A radio control apparatus, comprising:
a first radio controller, which in operation, acquires first information, using a first radio method, the first information including information indicating a first position of a person;
a second radio controller, which in operation, is connected to a radio apparatus, using a second radio method and acquires second information including apparatus identification information and information indicating a second position of the radio apparatus, the apparatus identification information identifying the radio apparatus; and
an information controller, which in operation, selects a first position within a predetermined range from each of a plurality of the second positions and identifies person identification information associated with the apparatus identification information of the second position, as person identification information for the person present at the selected first position.

2. The radio control apparatus according to claim 1, wherein
the radio apparatus is a station apparatus, and
the radio control apparatus is an access point apparatus that is connected to the station apparatus by radio.

3. The radio control apparatus according to claim 1, wherein
the first radio method is a radar method, and
the second radio method is a WiGig method.

4. The radio control apparatus according to claim 1, wherein the information controller controls a control target device to be connected to the radio control apparatus, based on identification information including a result of identifying the person identification information for the person present at the selected first position.

5. The radio control apparatus according to claim 4, wherein
the radio control apparatus is provided in a conference space, and
the information controller sets the person included in the identification information to be a participant of a conference to be held in the conference space.

6. The radio control apparatus according to claim 5, wherein
the control target device includes a microphone provided in the conference space,
the information controller determines whether or not a presenter who outputs speech to the microphone is present among a plurality of the participants, and
the information controller controls the microphone based on a position of the presenter and a position of the microphone when the presenter is present.

7. The radio control apparatus according to claim 5, wherein
the control target device includes a speaker provided in the conference space, and
the information controller controls volume output from the speaker, based on a position of the participant and a position of the speaker.

8. The radio control apparatus according to claim 5, wherein
the control target device includes a camera provided in the conference space,
the information controller determines whether or not a presenter is present among a plurality of the participants, and
the information controller controls a parameter relating to capturing performed by the camera, based on a position of the presenter and a position of the camera when the presenter is present.

9. The radio control apparatus according to claim 5, wherein
the control target device includes an air conditioning device provided in the conference space, and
the information controller controls the air conditioning device based on a number of a plurality of the participants and/or a position of at least one of the plurality of participants, and a position of the air conditioning device.

10. The radio control apparatus according to claim 5, wherein
the control target device includes a lighting device provided in the conference space, and
the information controller controls a first lighting device that illuminates a predetermined range from a position of the participant among a plurality of the lighting devices to be in an ON state and controls at least one of the plurality of lighting devices which is different from the first lighting device to be in an OFF state.

11. The radio control apparatus according to claim 5, wherein
the control target device includes a management device that manages reservation information including a person who makes a reservation for use of the conference space, and a use time, and
the information controller controls updating of the reservation information based on the reservation information and the identification information.

12. The radio control apparatus according to claim 11, wherein
the information controller deletes the reservation information when setting the participant in the conference space during the use time included in the reservation information, and
the information controller adds other reservation information for reserving use of the conference room when setting the participant in the conference space for a time different from the use time included in the reservation information.

13. The radio control apparatus according to claim 5, wherein
the control target device includes a conference system management device that provides information to a person who uses the conference space,
the information controller determines an index relating to quality of a conference in the conference room based on the first information including a heart rate of the participant, and
when the index is equal to or less than a predetermined value, the information controller instructs the conference system management device to provide information indicating suspending use of the conference room to the participant.

14. A radio control system, comprising:
a radio control apparatus; and
a radio apparatus to be connected to the radio control apparatus by radio, wherein
the radio control apparatus includes:
a first radio controller, which in operation, acquires first information, using a first radio method, the first information including information indicating a first position of a person;
a second radio controller, which in operation, is connected to the radio apparatus, using a second radio method and acquires second information including apparatus identification information and information indicating a second position of the radio apparatus, the apparatus identification information identifying the radio apparatus; and
an information controller, which in operation, selects, for each of a plurality of the second positions, at least a corresponding one of a plurality of the first positions, and identifies person identification information associated with the apparatus identification information of the second position, as person identification information for the person present at the selected first position.
